(19) United States
(12) Patent Application Publication
(10) Pub. No.: US 2026/0087782 A1
(43) Pub. Date: Mar. 26, 2026

(54) SYSTEM AND METHOD FOR VIDEO RESTORATION FOR HIGH-SPEED LOW BIT-DEPTH IMAGES

(71) Applicant: Purdue Research Foundation, West Lafayette, IN (US)

(72) Inventors: Stanley H. Chan, West Lafayette, IN (US); Prateek Chennuri, West Lafayette, IN (US); Yiheng Chi, West Lafayette, IN (US)

(73) Assignee: Purdue Research Foundation, West Lafayette, IN (US)

(21) Appl. No.: 19/340,166

(22) Filed: Sep. 25, 2025

Related U.S. Application Data
(60) Provisional application No. 63/699,146, filed on Sep. 25, 2024.

(51) Int. Cl. G06V 10/77; G06T 3/40; G06T 5/70; G06T 7/20; G06V 10/80

(52) U.S. Cl. CPC G06V 10/7715; G06T 3/40; G06T 5/70; G06T 7/20; G06V 10/806; G06T 2207/20084

(57) ABSTRACT

An image reconstruction system includes a single-photon detector array and a computing device. The single-photon detector array captures a time series of low-bit-depth image frames, which have a high temporal resolution (framerate). The computing device is configured to receive and process the time series of low bit-depth image frames to reconstruct a time series of high-quality reconstructed image frames. The image reconstruction pipeline leverages by the computing device incorporates a deep-learning-based, end-to-end neural network configured to reconstruct high-quality grayscale images from low bit-depth (e.g., 3-bit) quanta image data.

This application claims the benefit of priority of U.S. provisional application Ser. No. 63/799,246, filed on Sep. 25, 2024, the disclosure of which is herein incorporated by reference in its entirety.

### GOVERNMENT LICENSE RIGHTS

This invention was made with government support under U.S. Pat. No. 2,133,032 and ECCS-2030570 awarded by the National Science Foundation. The government has certain rights in the invention.

### FIELD

The devices and methods disclosed in this document relate to image processing and, more particularly, to video restoration for high-speed, low bit-depth images.

### BACKGROUND

Unless otherwise indicated herein, the materials described in this section are not admitted to be the prior art by inclusion in this section.

Over the past decade, the astonishing growth of single-photon detectors has fundamentally changed the landscape of computational imaging. With the invention and proliferation of quanta image sensors (QIS) and single-photon avalanche diodes (SPAD), there is an unprecedented volume of new applications in low-light imaging, computer vision, high-speed videography, time-of-flight sensing, and 3D imaging. In most of these use cases, the main core question that lies is how to recover the image from the photon counts measured in the scene. Specifically, given a video stream of 1-bit or few-bit data captured from a scene involving moving objects, how do we reconstruct a gray-scale image/video while eliminating the noise without incurring motion blur?

Conventional image and video denoising methods typically employ non-local strategies that identify and aggregate similar patches within an image or video. Deep neural networks have also been successful in producing high-quality denoised outputs. Among these architectures, Vision Transformers have recently been regarded as state-of-the-art. However, these solutions often make simplistic assumptions about noise statistics and therefore fail to perform well on real noisy images or videos. In low-light imaging, burst denoising, where images are aligned, merged, and denoised, is one of the most popular methods. These methods, however, fail without robust alignment. To address this, a number of alternative solutions with learnable alignment modules have been proposed. Recent approaches have also focused on practical noise models that replicate real camera sensor noise to produce visually appealing results. Nevertheless, existing solutions typically rely on images captured using CMOS image sensors, which operate at significantly higher photon levels than SPAD or QIS-based image sensors.

Prior work has demonstrated the use of SPADs in high-temporal-resolution imaging. For example, some prior works have employed SPADs at picosecond resolution to capture light in motion, while others have demonstrated two-dimensional motion tracking of planar objects at frame rates of up to 10,000 frames per second. More recently, passive imaging with SPADs has been explored in low-light environments. However, these methods rely on extremely high temporal resolutions, which hinder the deployment of SPADs in consumer devices where bandwidth is a bottleneck. Event cameras and spike cameras have also demonstrated effectiveness in capturing high-speed motion. These devices, however, focus on luminance variations and record a spike only when the variation exceeds a threshold (which can change depending on factors such as temperature and event rate). Therefore, unlike single-photon detectors such as QIS and SPADs, these cameras are not designed for single-photon counting and cannot operate in extremely low-light conditions.

Reconstructing quanta images is a challenging task due to the underlying Poisson-Gaussian statistics. Initial solutions to this problem included methods such as gradient descent, greedy algorithms, and the alternating direction method of multipliers (ADMM). Some prior work proposed a non-iterative approach using the Anscombe transform for reconstructing quanta images. Others have suggested using deep neural networks (DNN) for QIS reconstruction. Such DNN-based solutions include the use of Vision Transformers, Dual Prior Integrated networks, and related architectures. Nonetheless, these methods generally fail to produce good results when the scene contains motion.

What is needed are methods for reconstructing quanta images that can reliably reconstruct high-quality grayscale images and video from photon-limited data captured by single-photon detectors, particularly in dynamic low-light scenes where existing approaches struggle with noise and high-speed motion.

### SUMMARY

A method for reconstructing images captured using a single-photon detector array is disclosed herein. The method comprises receiving, with a processor, a predetermined number of consecutive image frames from a time series of image frames captured using the single-photon detector array. The consecutive image frames include an image frame at a time t. The method further comprises generating, with the processor, a reconstructed image frame at the time t based on the consecutive image frames using an end-to-end trainable neural network.

### BRIEF DESCRIPTION OF THE DRAWINGS

The foregoing aspects and other features of the methods and systems are explained in the following description, taken in connection with the accompanying drawings.

FIG. 1 shows an image reconstruction system for reconstructing images captured using a single-photon detector.

FIG. 2A shows a performance comparison of QUIVER with conventional techniques.

FIG. 2B illustrates the trade-off between motion blur and noise at different bit-depths for quanta images.

FIG. 3A summarizes the conventional approach for quanta image reconstruction.

FIG. 3B illustrates the limitations of the conventional approach.

FIG. 4 shows a flow diagram for a method for reconstructing images captured using a single-photon detector.

FIGS. 5A and 5B show an exemplary architecture of the end-to-end neural network.

FIG. 6 shows a detailed neural network architecture of the DC-GFU.

FIG. 7 shows a detailed neural network architecture of the RMDF.

FIG. 8 shows a detailed neural network architecture of the TCAM.

FIG. 9 shows a detailed neural network architecture of the RFRM.

FIG. 10 shows comparisons of the I2-2000FPS dataset and QUIVER with prior datasets and methods.

FIG. 11 shows visual comparisons of the reconstructed results on test videos from the I2-2000FPS dataset.

FIG. 12 shows performance on real quanta data.

### DETAILED DESCRIPTION

For the purposes of promoting an understanding of the principles of the disclosure, reference will now be made to the embodiments illustrated in the drawings and described in the following written specification. It is understood that no limitation to the scope of the disclosure is thereby intended. It is further understood that the present disclosure includes any alterations and modifications to the illustrated embodiments and includes further applications of the principles of the disclosure as would normally occur to one skilled in the art to which this disclosure pertains.

### Overview

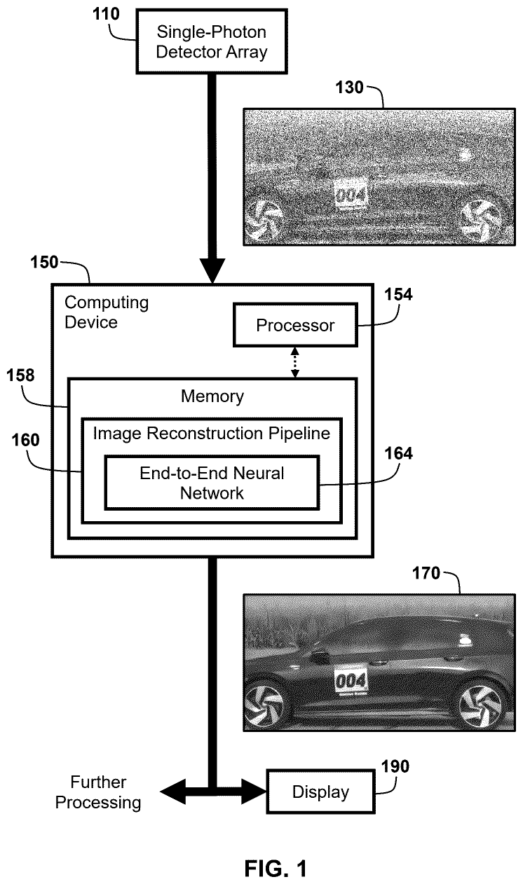

FIG. 1 shows an image reconstruction system 100 for reconstructing images captured using a single-photon detector. The image reconstruction system 100 includes a single-photon detector array 110 and a computing device 150. The single-photon detector array 110 captures a time series of low-bit-depth image frames 130, which have a high temporal resolution (framerate). The computing device 150 is configured to receive and process the time series of low bit-depth image frames to reconstruct a time series of high-quality reconstructed image frames 170.

The image reconstruction system 100 may be applied in a variety of applications in which sensitivity to low-light signals and high temporal resolution are required. Example applications include: biomedical imaging systems; scientific instrumentation; security systems; autonomous vehicles; and robotics systems. In general, any application that benefits from reconstructing high-quality images from photon-limited, high-frame-rate data streams may employ the image reconstruction system 100.

In at least some embodiments, the single-photon detector array 110 is a quanta image sensor (QIS) or single-photon avalanche diode (SPAD) array that captures photon-count data at a very high temporal resolution (i.e., framerate), for example 2000 frames per second (FPS). In operation, each pixel in the single-photon detector array 110 records whether one or more photons impinge upon it during an exposure window. Each image frame in the time series of low-bit-depth image frames 130 is a two-dimensional array of pixels. Each pixel records quanta image data in the form of a low bit-depth integer value (e.g., 1-bit, 2-bit, 3-bit, or 4-bit) representing the number of photons detected up to a small limit. For every exposure interval, each respective sensor element in the single-photon detector array 110 counts how many photons it has registered (e.g., 0 to 1 photon for 1-bit integers, 0 to 3 photons for 2-bit integers, 0 to 7 photons for 3-bit integers, or 0 to 15 photons for 4-bit integers), producing a binary or low-bit grayscale map.

The computing device 150 comprises at least a processor 154 and a memory 158. The processor 154 is configured to execute instructions to operate the computing device 150 to enable the features, functionality, characteristics, and/or the like as described herein. To this end, the processor 154 is operably connected to the memory 158. The processor 154 generally comprises one or more processors that may operate in parallel or otherwise in concert with one another. It will be recognized by those of ordinary skill in the art that a “processor” includes any hardware system, hardware mechanism, or hardware component that processes data, signals, or other information. Accordingly, the processor 154 may include a system with a central processing unit, graphics processing units, multiple processing units, dedicated circuitry for achieving functionality, programmable logic, or other processing systems. The memory 158 is configured to store data and program instructions that, when executed by the processor 154, enable the computing device 150 to perform various operations described herein. The memory 158 may be of any type of device capable of storing information accessible by the processor 154, such as a memory card, ROM, RAM, hard drives, discs, flash memory, or any of various other computer-readable media serving as data storage devices, as will be recognized by those of ordinary skill in the art.

The computing device 150 is configured to, given a video stream of 1-bit or few-bit data (i.e., the time series of low bit-depth image frames 130) captured from a scene involving moving objects, reconstruct a high-quality grayscale image/video (i.e., the time series of high-quality reconstructed image frames 170) that is free from both noise and motion blur. To these ends, the memory 158 stores program instructions implementing an image reconstruction pipeline 160, also referred to herein as QUanta VIdeo REstoration (QUIVER). The image reconstruction pipeline 160 incorporates a deep-learning-based, end-to-end neural network 164 configured to reconstruct high-quality grayscale images from quanta image data.

Depending on the application, in at least some embodiments, the computing device 150 outputs the time series of high-quality reconstructed image frames 170 to a display 190 (e.g., an LCD screen or equivalent) for display thereat. Alternatively, depending on the application, in at least some embodiments, the computing device 150 outputs the time series of high-quality reconstructed image frames 170 to another system (not shown), for further processing.

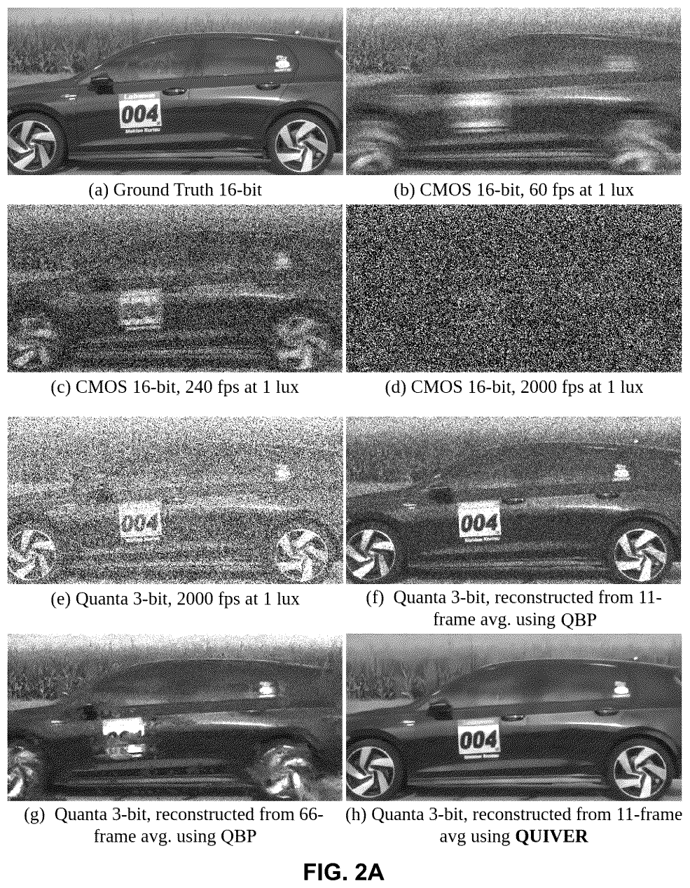

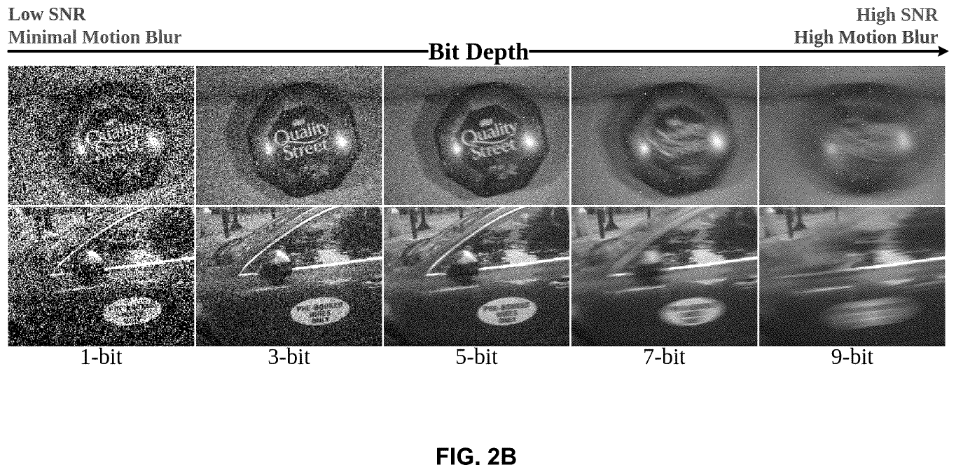

FIG. 2A shows a performance comparison of QUIVER with conventional techniques. To give the reader a visual perspective of the problem scope, illustration (a) depicts a blur-free video frame of a moving car. Illustrations (b), (c), and (d) show 16-bit CMOS images of the same video frame simulated at 1 lux and 60 fps, 240 fps, and 2000 fps, respectively, using realistic sensor specifications. The strong shot noise and read noise (5.1 e−/pix) of a realistic CMOS sensor make the signal acquisition difficult. As can be seen, the resulting CMOS outputs are either severely blurred due to strong motion or completely distorted by noise due to sparse photons. Illustration (e) shows a simulated 3-bit quanta image from a single-photon camera, in particular, a 3-bit QIS-based camera with low read noise (0.2 e−/pix). As can be seen, the content is largely preserved despite heavy noise. Illustrations (f) and (g) show reconstructions of the 3-bit quanta image using state-of-the-art Quanta Burst Photography (QBP), using 11-frame and 66-frame averages, respectively. As can be seen, provided the motion is slow, a decent output can be obtained. However, as the temporal window narrows, as shown in illustration (f), the noise remains. Likewise, as the temporal window widens, as shown in illustration (g), motion blur increases. Finally, illustration (h) shows a reconstruction of the 3-bit quanta image using QUIVER. As can be seen, QUIVER produces high-quality results and are designed to remove the noise while avoiding distortions in the presence of fast motion, while utilizing only a few frames.

FIG. 2B illustrates the trade-off between motion blur and noise at different bit-depths for quanta images. Particularly, the effects of bit-depth on signal-to-noise ratio (SNR) and motion blur are illustrated using real captures by a single-photon sensor. The left-most images in FIG. 2B are captured using a 1-bit SPAD at 10K fps at an average photon level of 0.51 and 0.40 photons-per-pixel (PPP) per frame, respectively. Moving from left to right, higher bit-depth outputs are generated through temporal frame averaging.

Single-photon detectors (QIS and SPAD) differ from conventional CMOS pixels by their extraordinary photon-counting capability. QIS uses a two-stage pump-gate technique and correlated double sampling to suppress the read noise, while SPAD uses avalanche multiplication to amplify the photocharge. In both cases, the sensors are capable of resolving photons up to a single-photon sensitivity.

Along with the single-photon detectors' unique capability to count individual photons, these devices can generate data at a bit-depth as low as 1-bit to as high as 16-bit or even more. However, higher bit-depth is accompanied by longer integration time. If the scene contains motion, a longer integration time will eventually result in strong motion blurs as shown in FIG. 2B. On the other hand, 1-bit sensing with high frame rates will result in motion-blur-free but extremely noisy images. Therefore, from a pure data acquisition perspective, there exists an optimal bit-depth with respect to the motion that will give us minimal/no motion-blur data with a minimum per-frame signal-to-noise ratio (SNR) required for good quality reconstruction. In at least some embodiments, e.g., applications having a particular motion range and particular lighting conditions, 3-bit single-photon detectors provide the best trade-off between blur and SNR. However, it should be appreciated that this optimal value may vary depending on the application.

Readers familiar with single-photon counting may wonder whether we can collect as many 1-bit frames as possible and then process the data afterward. However, the problem with this approach is power consumption and data rate. Fixing the same level of exposure, as described in Table 1 below, a 1-bit video at 10k fps would require 96 Mb/sec, whereas a 9-bit video at 20 fps would only need 1.73 Mb/sec. Another problem is read noise accumulation. For sensors with non-zero read noise (such as QIS), every frame contributes to a finite amount of read noise. The more frames we read, the more read noise we accumulate. Therefore, recording 1-bit data is not always the best option.

Table 1, below, shows frame-rate, motion, read-noise, and data-rate statistics for various bit-depths at the same exposure level.

| | | Motion | σ_{read} | Data-rate |
|---|---|---|---|---|
| Bit-Depth | fps | (pixels/frame) | (/pixel/sec) | (Mb/sec) |
| 1 | 10k | 0-1 | 2000 e⁻ | 96 |
| 3 | 1428 | 2-3 | 285.6 e⁻ | 41.13 |
| 5 | 323 | 6-12 | 64.6 e⁻ | 15.5 |
| 7 | 78 | 25-30 | 15.6 e⁻ | 5.24 |
| 9 | 20 | 70-80 | 4 e⁻ | 1.73 |

### Methods for Few-Bit Quanta Image Reconstruction

In this disclosure, a methodology to reconstruct blur-free grayscale images/videos captured using 1-bit or few-bit quanta data is presented. While adopting the ideology of classical quanta restoration methods, the proposed methodology advantageously incorporates an end-to-end deep learning framework, QUIVER, that utilizes pre-filtering, a learnable optical flow module, and a multi-scale reconstruction approach to produce high-quality visual outputs. Experiments on synthetic and real data indicate QUIVER beats the state-of-the-art and can generalize across single-photon sensors.

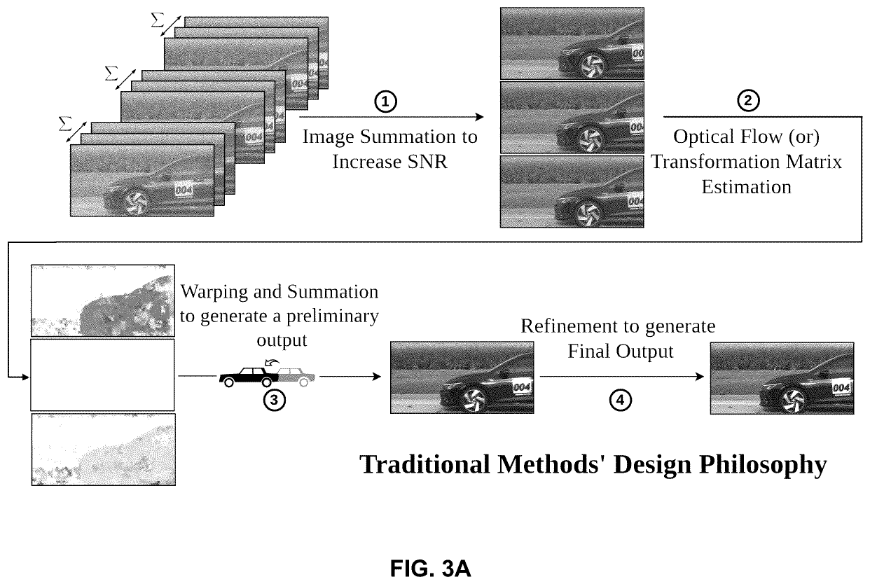

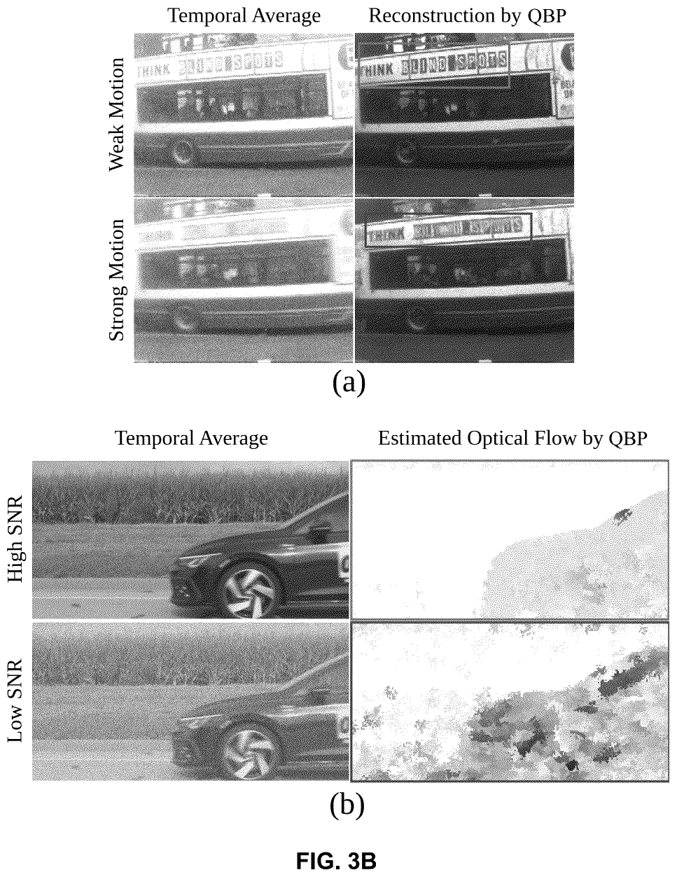

In order to provide a better understanding of the approach adopted in this disclosure, the design of conventional approaches for quanta image reconstruction is briefly reviewed. FIG. 3A summarizes the conventional approach for quanta image reconstruction. The conventional approach can be divided into four stages. In a first stage (1), sequential quanta images are summed together to increase the SNR prior to further processing. Next, in a second stage (2), the input frames are aligned using optical flow or transformation matrix estimation. Next, in a third stage (3), a preliminary restored output is generated through warping and linear combination. Finally, in a fourth stage (4), the final output is produced through refinement. While the steps seem intuitive and straightforward, existing methods are heavily vulnerable to extreme noise and strong motion in the input frames, primarily due to two reasons. First, none of the stages are designed to handle extreme noise and strong motion simultaneously. Second, since all the stages are sequential yet independent of each other, it is difficult to obtain an optimal result for a wide range of noise and motion.

FIG. 3B illustrates the limitations of the conventional approach. Particularly, in illustration (a), reconstruction through temporal averaging is compared with reconstruction through QBP, in scenarios with strong motion and in scenarios with weak motion. As can be seen, both of these conventional approaches fail in scenarios with strong motion. It is clearly visible in the restored images that an input with strong motion between the frames results in several artifacts in the output, even though SNR levels are similar. In illustration (b), optical flow estimation through temporal averaging is compared with optical flow estimation through QBP, in scenarios with low SNR and in scenarios with high SNR. These conventional approaches utilize a patch-based pre-trained optical flow module. As can be seen, the optical flow module fails to compensate for motion in the presence of significant noise.

A variety of methods, operations, and processes are described below for operating the computing device 150 to reconstruct images captured using a single-photon detector. In these descriptions, statements that a method, processor, and/or system is performing some task or function refers to a controller or processor (e.g., the processor 154 of the computing device 150) executing programmed instructions (e.g., the image reconstruction pipeline 160 and the end-to-end neural network 164) stored in non-transitory computer readable storage media (e.g., the memory 158 of the computing device 150) operatively connected to the controller or processor to manipulate data or to operate one or more components in the computing device 150 to perform the task or function. Additionally, the steps of the methods may be performed in any feasible chronological order, regardless of the order shown in the figures or the order in which the steps are described.

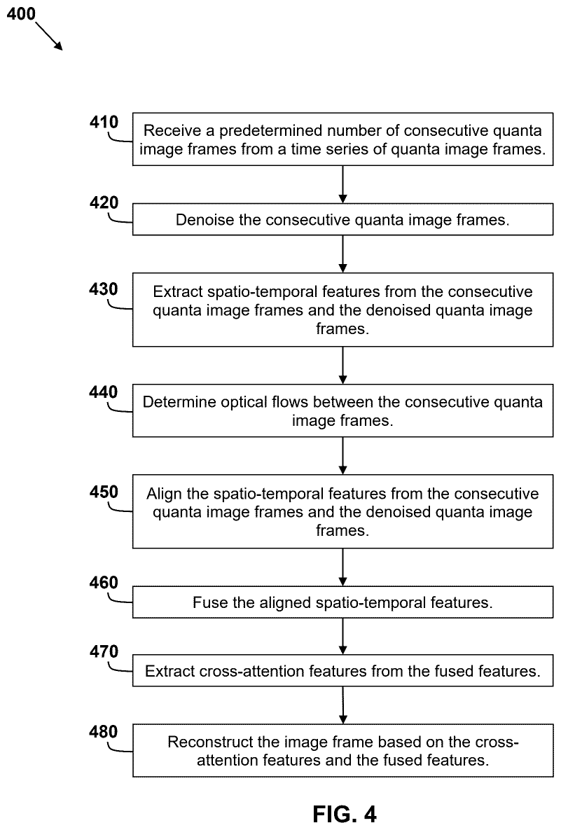

FIG. 4 shows a flow diagram for a method 400 for reconstructing images captured using a single-photon detector. The method 400 advantageously leverages the deep-learning-based, end-to-end neural network 164 (QUIVER) to reconstruct high-quality grayscale images from quanta image data. The end-to-end neural network 164 adopts a multi-stage approach in which each stage simultaneously handles both noise and motion. Moreover, the end-to-end neural network 164 is an end-to-end trainable model, making all the stages interdependent, thus leading to good restoration outputs.

The method 400 is described primarily with respect to the reconstruction of a single quanta image frame Iₜ from a time series of quanta image frames. However, it should be appreciated that the method 400 will typically be performed repeatedly to reconstruct all of the quanta image frames in the time series of quanta image frames to provide a high-quality reconstructed grayscale video.

The method 400 begins with receiving a predetermined number of consecutive quanta image frames from a time series of quanta image frames (block 410). Particularly, the processor 154 of the computing device 150 receives at least a predetermined number of consecutive quanta image frames from a time series of quanta image frames captured using the single-photon detector array 110. The predetermined number of consecutive quanta image frames includes quanta image frame Iₜ at the time t. In one embodiment, the predetermined number of consecutive quanta image frames includes a sequence of 11 sequential quanta image frames from the time series of quanta image frames. In one embodiment, the predetermined number of consecutive quanta image frames includes an equal number of prior quanta image frames and subsequent quanta image frames, e.g., {Iₜ₋₅, . . . , Iₜ, . . . , Iₜ₊₅}.

The time series of quanta image frames is captured with a predetermined framerate by the single-photon detector array 110 (e.g., 2000 frames per second), with an average motion range of, for example 1 to 7 pixels per frame. Each quanta image frame has dimensions N×M×C, where N is the height of the quanta image frame, M is the width of the quanta image frame, and C is the number of channels of the quanta image data. Each pixel of the quanta image frame includes an intensity value having a pre-determined bit depth. In at least one embodiment, each intensity value is a count of individual photons that were received during a respective exposure window by a respective sensor element in the single-photon detector array 110. In at least one embodiment, the quanta image frames include 3-bit depth intensity values representing an integer number of photons between 0 and 7 photons.

As described in greater detail below, the processor 154 uses the end-to-end neural network 164 to generate a reconstructed quanta image frame Oₜ at the time t based on the predetermined number of consecutive quanta image frames {Iₜ₋₅, . . . , Iₜ, . . . , Iₜ₊₅}. As discussed below in further detail, some portions of the end-to-end neural network 164 process information in a multi-scale manner. In such cases, the consecutive quanta image frames {Iₜ₋₅, . . . , Iₜ, . . . , Iₜ₊₅} are denoted

$$\{ {I}_{t - 5}^{1} , … , {I}_{t}^{1} , … , {I}_{t + 5}^{1} \} ,$$

where the superscript 1 indicates the original (full-sized) image scale.

The method 400 continues with denoising the consecutive quanta image frames (block 420). Particularly, the processor 154 of the computing device 150 determines denoised consecutive quanta image frames

$$\{ {I}_{t - 5 , d}^{1} , … , {I}_{t , d}^{1} , … , {I}_{t + 5 , d}^{1} \}$$

by denoising the consecutive quanta image frames

$$\{ {I}_{t - 5}^{1} , … , {I}_{t}^{1} , … , {I}_{t + 5}^{1} \}$$

using a denoiser sub-network of the end-to-end neural network 164. In at least one embodiment, the denoised consecutive quanta image frames

$$\{ {I}_{t - 5 , d}^{1} , ⋯ , {I}_{t , d}^{1} , ⋯ , {I}_{t + 5 , d}^{1} \}$$

have the same dimensions N×M×C as the consecutive quanta image frames

$$\{ {I}_{t - 5}^{1} , ⋯ , {I}_{t}^{1} , ⋯ , {I}_{t + 5}^{1} \} .$$

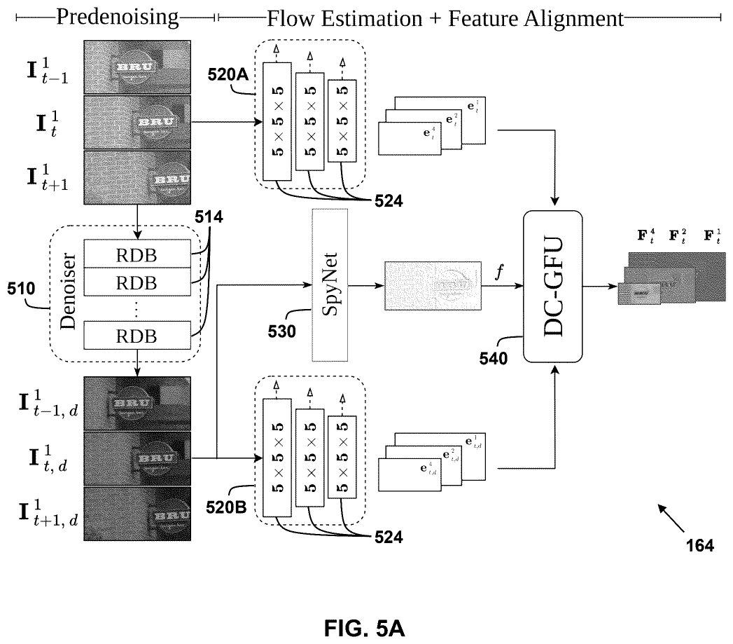

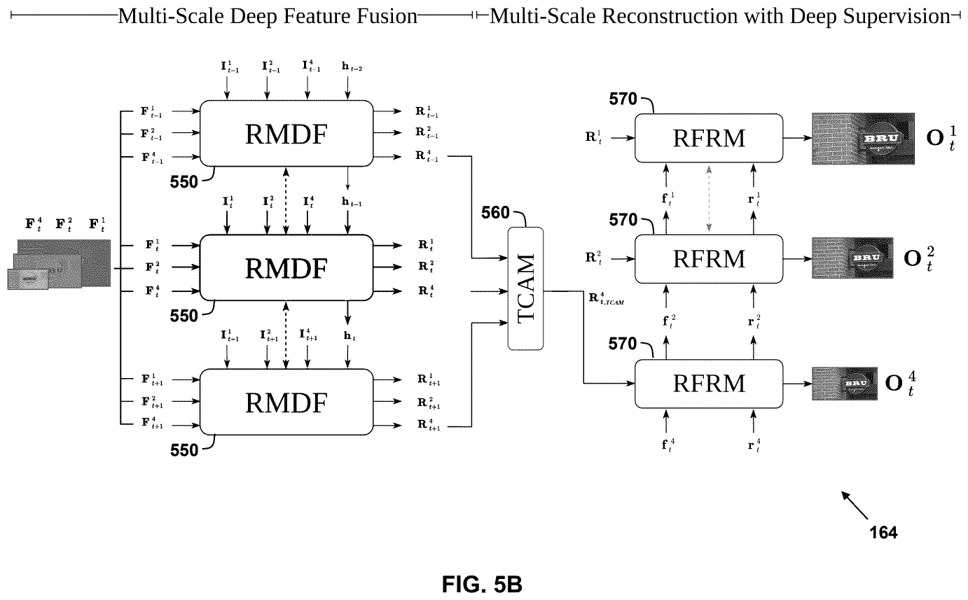

FIGS. 5A and 5B show an exemplary architecture of the end-to-end neural network 164. In the illustrations, the end-to-end neural network 164 is split into two figures for improved clarity. However, it should be appreciated that the end-to-end neural network 164 is an end-to-end trainable neural network architecture. With reference to FIG. 5A, an exemplary denoiser sub-network 510 is illustrated. Particularly, the denoiser sub-network 510 receives the set of consecutive quanta image frames

$$\{ {I}_{t - 5}^{1} , ⋯ , {I}_{t}^{1} , ⋯ , {I}_{t + 5}^{1} \}$$

(only three of the consecutive frames are illustrated for simplicity). The denoiser sub-network 510 receives the consecutive quanta image frames

$$\{ {I}_{t - 5}^{1} , ⋯ , {I}_{t}^{1} , ⋯ , {I}_{t + 5}^{1} \}$$

and outputs the denoised consecutive quanta image frames

$$\{ {I}_{t - 5 , d}^{1} , ⋯ , {I}_{t , d}^{1} , ⋯ , {I}_{t + 5 , d}^{1} \} .$$

In at least some embodiments, the denoiser sub-network 510 includes residual dense blocks (RDB) 514 configured to denoise the noisy input quanta image frames.

Since the input quanta frames

$$\{ {I}_{t - 5}^{1} , ⋯ , {I}_{t}^{1} , ⋯ , {I}_{t + 5}^{1} \}$$

possess extreme noise, conventional methods typically adopt naive averaging to increase the SNR and thereby predict better optical flows or transformation matrices. However, as shown previously in illustration (b) of FIG. 3B, the simple averaging is vulnerable to motion and will negatively impact subsequent processing, ultimately leading to distorted outputs. However, simply eliminating this stage is not a suitable solution, because it leads to poor optical flow estimation, resulting in over-smoothed outputs with a lack of low-level intricate details. Therefore, a preliminary denoising (“predenoising”) step robust to noise and motion is crucial. To these ends, the denoiser sub-network 510 is advantageously a computational undemanding single-image denoiser built using RDBs to provide minimal preliminary preprocessing of the input quanta data.

Returning to FIG. 4, the method 400 continues with extracting spatio-temporal features from the consecutive quanta image frames and the denoised quanta image frames (block 430). Particularly, the processor 154 of the computing device 150 extracts spatio-temporal features eₜ from the consecutive quanta image frames

$$\{ {I}_{t - 5}^{1} , ⋯ , {I}_{t}^{1} , ⋯ , {I}_{t + 5}^{1} \}$$

using a first feature extraction sub-network 520A. Additionally, the processor 154 extracts spatio-temporal features e_{t,d} from the denoised consecutive quanta image frames

$$\{ {I}_{t - 5 , d}^{1} , ⋯ , {I}_{t , d}^{1} , ⋯ , {I}_{t + 5 , d}^{1} \}$$

using a second feature extraction sub-network 520B. In at least one embodiment, the extracted spatio-temporal features eₜ and e_{t,d} have the same dimensions N×M×C as the consecutive quanta image frames

$$\{ {I}_{t - 5}^{1} , ⋯ , {I}_{t}^{1} , ⋯ , {I}_{t + 5}^{1} \} .$$

In at least some embodiments, the processor 154 of the computing device 150 extracts the spatio-temporal features eₜ and e_{t,d} at multiple image scales, in which case the extracted features from the consecutive quanta image frames

$$\{ {I}_{t - 5}^{1} , ⋯ , {I}_{t}^{1} , ⋯ , {I}_{t + 5}^{1} \}$$

are denoted

$${e}_{t}^{1} , {e}_{t}^{2} , and {e}_{4}^{4} and {e}_{t , d}^{1} , {e}_{t , d}^{2} , and {e}_{t , d}^{4} ,$$

where the superscript 1 indicates the original (full-sized) image scale of N×M×C, the superscript 2 indicates a halved image scale of N/2×M/2×C, and the superscript 4 indicates a quartered image scale of N/4×M/4×C.

To these ends, in one embodiment, the processor 154 determines downscaled consecutive quanta image frames

$$\{ {I}_{t - 5}^{2} , ⋯ , {I}_{t}^{2} , ⋯ , {I}_{t + 5}^{2} \} and \{ {I}_{t - 5}^{4} , ⋯ , {I}_{t}^{4} , ⋯ , {I}_{t + 5}^{4} \}$$

from the consecutive quanta image frames

$$\{ {I}_{t - 5}^{1} , ⋯ , {I}_{t}^{1} , ⋯ , {I}_{t + 5}^{1} \} ,$$

for example using bicubic sampling or bilinear interpolation. Next, the processor 154 determines the multi-scale spatio-temporal features

$${e}_{t}^{1} , {e}_{t}^{2} , and {e}_{t}^{4}$$

based on the consecutive quanta image frames at each image scale. Similarly, in one embodiment, the processor 154 determines downscaled denoised consecutive quanta image frames

$$\{ {I}_{t - 5 , d}^{2} , ⋯ , {I}_{t , d}^{2} , ⋯ , {I}_{t + 5 , d}^{2} \} and \{ {I}_{t - 5 , d}^{4} , ⋯ , {I}_{t , d}^{4} , ⋯ , {I}_{t + 5 , d}^{4} \}$$

from the denoised consecutive quanta image frames

$$\{ {I}_{t - 5 , d}^{1} , ⋯ , {I}_{t , d}^{1} , ⋯ , {I}_{t + 5 , d}^{1} \} ,$$

for example using bicubic sampling or bilinear interpolation. Next, the processor 154 determines the multi-scale spatio-temporal features

$${e}_{t , d}^{1} , {e}_{t , d}^{2} , and {e}_{t , d}^{4}$$

based on the denoised consecutive quanta image frames at each image scale. In alternative embodiments, the feature extraction sub-networks 520A and 520B may be configured to directly output the multi-scale spatio-temporal features based only on the original scale input frames.

With reference to FIG. 5A, exemplary feature extraction sub-networks 520A and 520B are illustrated. Particularly, the first feature extraction sub-network 520A receives the set of the consecutive quanta image frames

$$\{ {I}_{t - 5}^{1} , ⋯ , {I}_{t}^{1} , ⋯ , {I}_{t + 5}^{1} \} .$$

The consecutive quanta image frames

$$\{ {I}_{t - 5}^{1} , ⋯ , {I}_{t}^{1} , ⋯ , {I}_{t + 5}^{1} \}$$

are stacked channel-wise into an input matrix having N×M×11C and the first feature extraction sub-network 520A processes the input matrix to output the spatio-temporal features eₜ¹. The same process is repeated for the downscaled consecutive quanta image frames

$$\{ {I}_{t - 5}^{2} , ⋯ , {I}_{t}^{2} , ⋯ , {I}_{t + 5}^{2} \}$$

$$and$$

$$\{ {I}_{t - 5}^{4} , ⋯ , {I}_{t}^{4} , ⋯ , {I}_{t + 5}^{4} \}$$

to generate the spatio-temporal features

$${e}_{t}^{2} , and {e}_{t}^{4} .$$

Likewise, the second feature extraction sub-network 520B performs the same process to generate the multi-scale spatio-temporal features

$${e}_{t , d}^{1} , {e}_{t , d}^{2} , and {e}_{t , d}^{4}$$

based on the denoised consecutive quanta image frames

$$\{ {I}_{t - 5 , d}^{1} , ⋯ , {I}_{t , d}^{1} , ⋯ , {I}_{t + 5 , d}^{1} \} , \{ {I}_{t - 5 , d}^{2} , ⋯ , {I}_{t , d}^{2} , ⋯ , {I}_{t + 5 , d}^{2} \} , and \{ {I}_{t - 5 , d}^{4} , ⋯ , {I}_{t , d}^{4} , ⋯ , {I}_{t + 5 , d}^{4} \} .$$

In at least some embodiments, the feature extraction sub-networks 520A and 520B each include one or more three-dimensional convolution layers 524 (e.g., three 5×5×5 layers) that operate in sequence to generate the spatio-temporal features.

Returning to FIG. 4, the method 400 continues with determining optical flows between the consecutive quanta image frames (block 440). Particularly, the processor 154 of the computing device 150 determines optical flows f between consecutive quanta image frames

$$\{ {I}_{t - 5}^{1} , ⋯ , {I}_{t}^{1} , ⋯ , {I}_{t + 5}^{1} \}$$

using an optical flow estimation sub-network 530 of the end-to-end neural network 164. The processor 154 at least determines optical flows f_{t→t+1} between the quanta image frame

$${I}_{t}^{1}$$

at the time t and a subsequent quanta image frame

$${I}_{t + 1}^{1}$$

at the subsequent time t+1. In at least some embodiments, the processor 154 determines optical flows f based on the denoised consecutive quanta image frames

$$\{ {I}_{t - 5 , d}^{1} , ⋯ , {I}_{t , d}^{1} , ⋯ , {I}_{t + 5 , d}^{1} \} .$$

In at least some embodiments, the processor 154 determines optical flows f at multiple image scales, resulting in optical flows f¹, f², and f⁴, which at least includes optical flows

$${f}_{t \to t + 1}^{1} , {f}_{t \to t + 1}^{2} and {f}_{t \to t + 1}^{4} .$$

In some embodiments, the processor 154 determines optical flows f bidirectionally, including determining optical flows

$${f}_{t \to t + 1}^{1} , {f}_{t \to t + 1}^{2} , and {f}_{t \to t + 1}^{4}$$

and optical flows

$${f}_{t + 1 \to t}^{1} , {f}_{t + 1 \to t}^{2} , and {f}_{t + 1 \to t}^{4} .$$

In at least some embodiments, the optical flows f have the same dimensions N×M×C as the image frames, and have the dimensions N/2×M/2×C or N/4×M/4×C for the halfed and quartered image scales, respectively.

With reference to FIG. 5A, an exemplary optical flow estimation sub-network 530 is illustrated. Particularly, the optical flow estimation sub-network 530 receives the multi-scale spatio-temporal features

$${e}_{t , d}^{1} , {e}_{t , d}^{2} , and {e}_{t , d}^{4}$$

from the feature extraction sub-network 520B and processes them to determine the optical flows f discussed above. In at least one embodiment, the optical flow estimation sub-network 530 is a spatial pyramid neural network (SPyNet).

It should be appreciated that conventional methods typically utilize an off-the-shelf pre-trained optical flow estimation module or predict a transformation matrix to compensate for motion between the frames. The basic assumption behind such approaches is that the motion between the frames is limited and the SNR is high enough. However, when such an assumption is not met, the motion compensation is sub-optimal, as shown in illustration (b) of FIG. 3B. As most state-of-the-art pre-trained optical flow estimators are optimized on CMOS RGB sensor images, this leads to sub-optimal performance when applied to quanta image frames. The end-to-end neural network 164 advantageously employs a learnable optical flow estimation module and utilizes SPyNet owing to its computational efficiency while using a multi-scale approach.

Returning to FIG. 4, the method 400 continues with aligning the spatio-temporal features from the consecutive quanta image frames and the denoised quanta image frames (block 450). Particularly, the processor 154 of the computing device 150 determines aligned spatio-temporal features Fₜ at the time t by aligning the spatio-temporal features eₜ and e_{t,d} based on the optical flows f using a feature alignment sub-network of the end-to-end neural network 164. In at least some embodiments, the processor 154 determines aligned spatio-temporal features at multiple image scales, in which case multi-scale aligned spatio-temporal features

$${F}_{t}^{1} , {F}_{t}^{2} , and {F}_{t}^{4}$$

are determined based on the multi-scale spatio-temporal features

$${e}_{t}^{1} , {e}_{t}^{2} , and {e}_{t}^{4} and {e}_{t , d}^{1} , {e}_{t , d}^{2} , and {e}_{t , d}^{4}$$

and the multi-scale optical flows

$${f}_{t \to t + 1}^{2 \; 1} , {f}_{t \to t + 1}^{2} , and {f}_{t \to t + 1}^{4} .$$

With reference to FIG. 5A, an exemplary feature alignment sub-network is illustrated. In particular, the end-to-end neural network 164 incorporates a Deformable Convolution-Gated Fusion Unit (DC-GFU) 540 configured to determine the aligned spatio-temporal features

$${F}_{t}^{1} , {F}_{t}^{2} , and {F}_{t}^{4}$$

at the time t by aligning the spatio-temporal features

$${e}_{t}^{1} , {e}_{t}^{2} , and {e}_{t}^{4} and {e}_{t , d}^{1} , {e}_{t , d}^{2} , and {e}_{t , d}^{4}$$

based on the optical flows f.

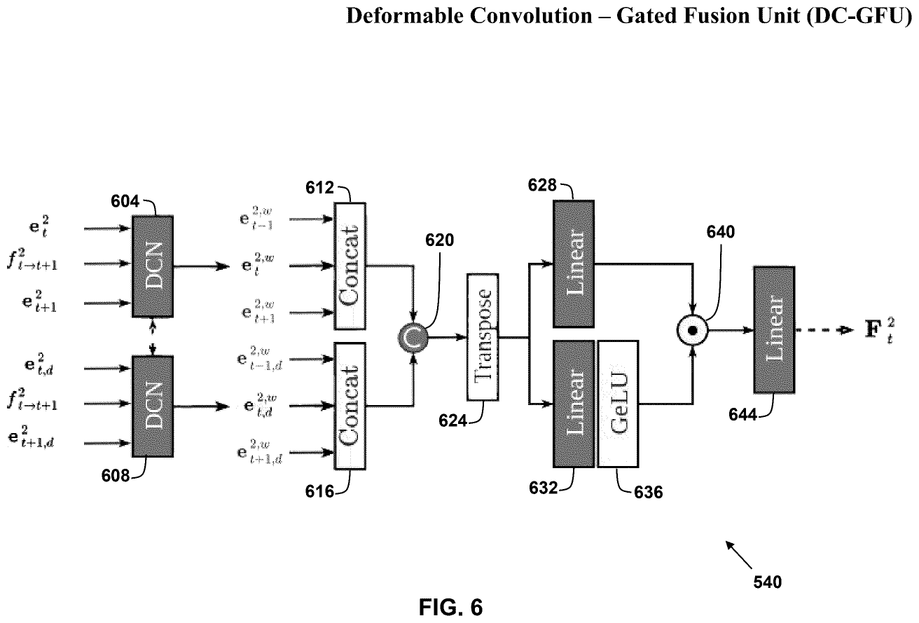

FIG. 6 shows a detailed neural network architecture of the DC-GFU 540. In the illustration, processing is only shown for one of the image scales (the halved image scale). However, it should be appreciated that this architecture can be duplicated for the other image scales or reused for the other image scales. The DC-GFU 540 includes deformable convolution layers (DCN) 604, 608 with residual offsets. The DCN 604 receives

$${e}_{t}^{2} , {f}_{t \to t + 1}^{2} , and {e}_{t + 1}^{2}$$

and generates warped spatio-temporal features

$${e}_{t , d}^{2} , {f}_{t \to t + 1}^{2} , and {e}_{t + 1 , d}^{2}$$

Similarly, the DCN 608 receives

$${e}_{t , d}^{2} , {f}_{t \to t + 1}^{2} , and {e}_{t + 1 , d}^{2}$$

and generates warped spatio-temporal features

$${e}_{t , d}^{2 , w} .$$

Concatenation layers 612, 616 and concatenating node 620 concatenate, channel-wise, the warped spatio-temporal features

$${e}_{t}^{2 , w} and {e}_{t , d}^{2 , w}$$

with the warped spatio-temporal features

$${e}_{t - 1}^{2 , w} and {e}_{t - 1 , d}^{2 , w}$$

from the previous time step t−1 and the warped spatio-temporal features

$${e}_{t + 1}^{2 , w} and {e}_{t + 1 , d}^{2 , w}$$

from the subsequent time step t+1. As can be seen, the estimated multi-scale robust-to-noise optical flows f are utilized for feature-level alignment of the extracted multi-scale spatio-temporal features. The noisy frames are reused to compensate for any information lost in the pre-denoising stage. Deformable convolution with residual offsets is utilized to warp the features.

Next, the concatenated warped spatio-temporal features are transposed by a transpose layer 624, and then fused together to determine the aligned spatio-temporal features

$${F}_{t}^{2}$$

using a Gated Linear Unit (GLU)-based multi-layer perceptron. In particular, after being transposed, the concatenated warped spatio-temporal features are provided to linear layers 628, 632 on parallel processing paths. One of the linear layers 632 is followed by GeLU activation 636. The outputs of the linear layer 628 and of the GeLU activation 636 are subjected to element-wise multiplication by a multiplication node 640. Finally, the output from the multiplication node 640 is provided to a final linear layer 644 to generate the aligned spatio-temporal features

$${F}_{t}^{2} .$$

Inspired by the superior performance of GLUs in Transformers, this GLU-based multi-layer perceptron with GeLU activation is used to efficiently fuse the aligned features extracted from both the noisy and denoised frames. At this fusion stage, each frame is processed separately, and the fusion is performed only along the channel dimension.

Returning to FIG. 4, the method 400 continues with fusing the aligned spatio-temporal features (block 460). Particularly, the processor 154 of the computing device 150 determines, using a dense feature fusion sub-network of the end-to-end neural network 164, fused features Rₜ at the time t based on the aligned spatio-temporal features Fₜ, the quanta image frame Iₜ at the time t, and a hidden state hₜ₋₁ at a prior time t−1 that resulted from reconstructing a prior quanta image frame Iₜ₋₁ at the prior time t−1. In at least some embodiments, the processor 154 determines fused features at multiple image scales, in which case, multi-scale fused features

$${R}_{t}^{1} , {R}_{t}^{2} , and {R}_{t}^{4}$$

are determined based on the multi-scale aligned spatio-temporal features

$${F}_{t}^{1} , {F}_{t}^{2} , and {F}_{t}^{4} ,$$

the quanta image frames

$${I}_{t}^{1} , {I}_{t}^{2} , and {I}_{t}^{4}$$

at the multiple image scales, and the hidden state hₜ₋₁.

With reference to FIG. 5B, an exemplary dense feature fusion sub-network is illustrated. In particular, the end-to-end neural network 164 incorporates a Recurrent Multi-Scale Residual Dense Feature Fusion Unit (RMDF) 550 configured to determine the fused features

$${R}_{t}^{1} , {R}_{t}^{2} , and {R}_{t}^{4}$$

at the time t by densely fusing the aligned spatio-temporal features

$${F}_{t}^{1} , {F}_{t}^{2} , and {F}_{t}^{4}$$

using the quanta image frames

$${I}_{t}^{1} , {I}_{t}^{2} , and {I}_{t}^{4}$$

and the hidden state hₜ₋₁. The RMDF 550 performs a robust-to-noise dense feature fusion while taking advantage of the temporal correlations among the features of all the input frames and also the spatial correlations between the multi-scale features within the same frame. The recurrence comes from the fact that the same RMDF 550 is applied progressively to all the frames' features. For any frame t, the RMDF 550 takes in the corresponding frame's multi-scale aligned spatio-temporal features

$${F}_{t}^{1} , {F}_{t}^{2} , {F}_{t}^{4} ,$$

the noisy frames

$${I}_{t}^{1} , {I}_{t}^{2} , {I}_{t}^{4} ,$$

and a hidden state hₜ₋₁ as inputs. The multi-scale features are progressively fused in a feed-forward fashion to effectively extract both the short-range and long-range dependencies that enable good reconstruction.

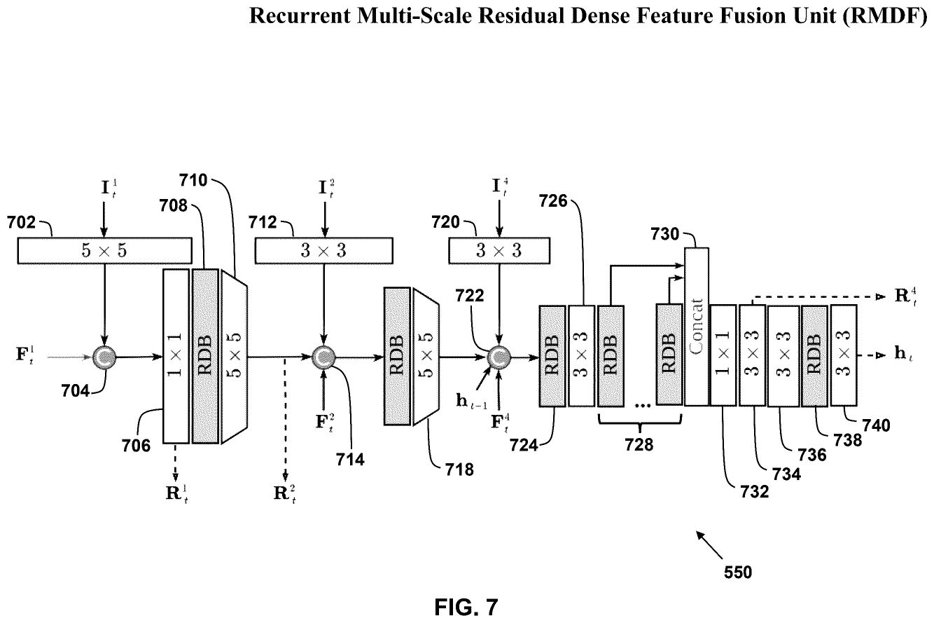

FIG. 7 shows a detailed neural network architecture of the RMDF 550. The quanta image frame

$${I}_{t}^{1}$$

is passed through a convolutional layer 702 (e.g., 5×5) and then concatenated with the aligned spatio-temporal features

$${F}_{t}^{1}$$

by a concatenation node 704. These concatenated features are then passed through a convolutional layer 706 (e.g., 1×1) to determine the fused features

$${R}_{t}^{1} ,$$

which are output by the RMDF 550. The fused features

$${R}_{t}^{1}$$

are also passed through a Residual Dense Block (RDB) 708 and a further convolutional layer 710 (e.g., 5×5), which reduces the dimensionality of the data down to the halved image scale, to provide the half-scaled fused features

$${R}_{t}^{2} ,$$

which are output by the RMDF 550. Next, the half-scaled quanta image frame

$${I}_{t}^{2}$$

is passed through a convolutional layer 712 (e.g., 3×3) and then concatenated with the half-scaled aligned spatio-temporal features

$${F}_{t}^{2}$$

and the half-scaled fused features

$${R}_{t}^{2}$$

by a concatenation node 714. These concatenated features are then passed through a RDB 716 and a further convolutional layer 718 (e.g., 5×5), which reduces the dimensionality of the data down to the quartered image scale. Next, the quarter-scaled quanta image frame

$${I}_{t}^{4}$$

is passed through a convolutional layer 720 (e.g., 3×3) and then concatenated, using a concatenation node 722, with the quarter-scaled aligned spatio-temporal features

$${F}_{t}^{4} ,$$

the quarter-scaled output from the convolutional layer 718, and a hidden state hₜ₋₁ that was output by the RMDF 550 at the prior time step t−1. These concatenated features are then passed through a RDB 724 and a further convolutional layer 726 (e.g., 3×3). The output of the further convolutional layer 726 is passed through a sequence of RDB 728, and the outputs of each RDB 728 are concatenated together by a concatenation layer 730. These concatenated outputs are passed through convolutional layers 732, 734 (e.g., 1×1 and 3×3) to generate the quarter-scaled fused features

$${R}_{t}^{4} ,$$

which are output by the RMDF 550. Finally, the quarter-scaled fused features

$${R}_{t}^{4}$$

are passed through a convolutional layer 736 (e.g., 3×3), a RDB 738, and a convolutional layer 740 (e.g., 3×3) to generate the hidden state hₜ for the time step t.

As can be seen in FIG. 7), the multi-scale aligned features extracted from the noisy frames are fused with the other corresponding input features to minimize any errors accumulated through the previous stages. While these features are utilized to exploit the spatial correlations within the frame, the hidden state h captures the temporal correlations between all the input frames. Thus, the design of RMDF 550 enables it to extract densely fused multi-scale spatio-temporal features required for enhanced quality outputs.

Returning to FIG. 4, the method 400 continues with extracting cross-attention features from the fused features (block 470). Particularly, the processor 154 of the computing device 150 extracts cross-attention features R_{t,TCAM} based on the fused features Rₜ at the time t, as well as the fused features Rₜ₋₁ at the previous time step t−1 and the fused features Rₜ₊₁ at the subsequent time step t+1, using a temporal cross-attention sub-network of the end-to-end neural network 164. More particularly, in the multi-scale case, the processor 154 extracts quarter-scaled cross-attention features

$${R}_{t , TCAM}^{4}$$

based on the smallest-scaled (e.g., quarter-scaled) fused features

$${R}_{t - 1}^{4} , {R}_{t}^{4} and {R}_{t + 1}^{4} .$$

With reference to FIG. 5B, an exemplary temporal cross-attention sub-network is illustrated. In particular, the end-to-end neural network 164 incorporates a Temporal Cross Attention Module (TCAM) 560 configured to extract the cross-attention features

$${R}_{t , TCAM}^{4}$$

based on the quarter-scale fused features

$${R}_{t - 1}^{4} , {R}_{t}^{4} and {R}_{t + 1}^{4} .$$

Meanwhile, the full-scale fused features

$${R}_{t}^{1}$$

and the half-scale fused features

$${R}_{t}^{2}$$

at the time t bypass the TCAM 560 and are fed directly to the next stage.

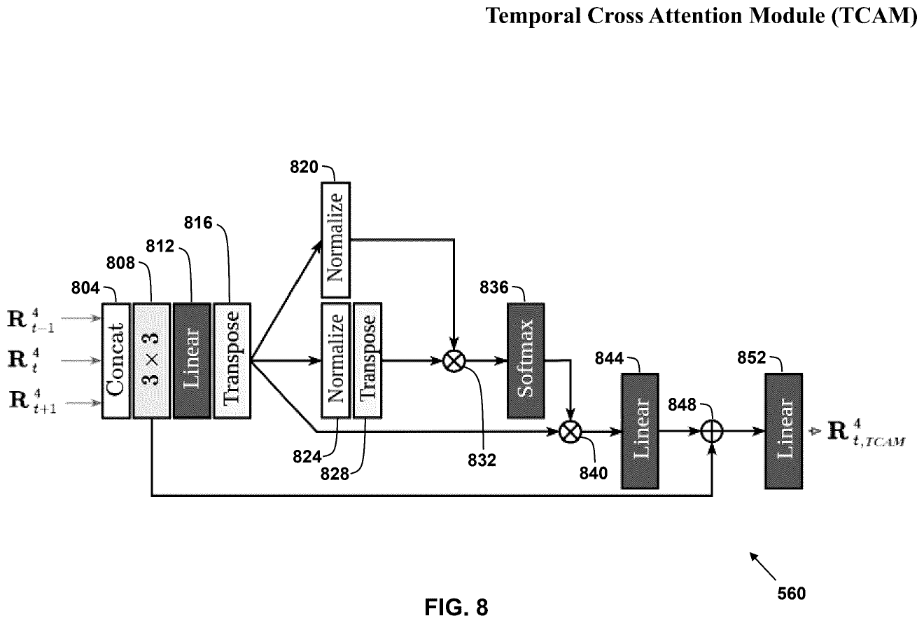

FIG. 8 shows a detailed neural network architecture of the TCAM 560. The smallest-scaled fused features

$${R}_{t - 1}^{4} , {R}_{t}^{4} and {R}_{t + 1}^{4}$$

are concatenated by a concatenation layer 804. These concatenated features are passed through a convolutional layer 808 (e.g., 3×3) and a linear layer 812 before being transposed by a transpose layer 816. The transposed features from the transpose layer 816 are duplicated across three parallel processing paths. In a first path, the transposed features from the transpose layer 816 are normalized in a normalization layer 820. In a second path, the transposed features from the transpose layer 816 are normalized in a normalization layer 824 and transposed by a transpose layer 828. The normalized values from the normalization layer 820 and the transposed values from the transpose layer 828 are multiplied by a multiplication node 832 before applying a softmax layer 836. In the third path, the transposed features from the transpose layer 816 are passed directly to a multiplication node 840 and multiplied with the output of the softmax layer 836. These multiplied values are passed through a linear layer 844 and then summed with the output of the convolutional layer 808 by a summation node 848. Finally, these summed values are passed through a final linear layer 852 to determine the quarter-scaled cross-attention features

$${R}_{t , TCAM}^{4} .$$

As can be seen, the TCAM 560 is similar to the multi-head attention in vision transformers in terms of generating queries, keys, and values. However, the number of heads is maintained to be one, and attention is applied only on the channel dimension. The cross attention comes from the fact that input features are extracted from all the input frames.

Returning to FIG. 4, the method 400 continues with reconstructing the quanta image frame based on the cross-attention features and the fused features (block 480). Particularly, the processor 154 of the computing device 150 generates the reconstructed quanta image frame Oₜ at the time t based on the cross-attention features R_{t,TCAM} and the fused features Rₜ at the time t, using a reconstruction sub-network of the end-to-end neural network 164. More particularly, the processor 154 generates reconstructed quanta image frames

$${O}_{t}^{1} , {O}_{t}^{2} , and {O}_{t}^{4}$$

at the time t based on the quarter-scaled cross-attention features

$${R}_{t , TCAM}^{4}$$

and the full-scale fused features

$${R}_{t}^{1}$$

and the half-scaled fused features

$${R}_{t}^{2}$$

at the time t.

With reference to FIG. 5B, an exemplary reconstruction sub-network is illustrated. In particular, the end-to-end neural network 164 incorporates Residual Frame Refinement Modules (RFRM) 570 configured to generate the reconstructed quanta image frames

$${O}_{t}^{1} , {O}_{t}^{2} , and {O}_{t}^{4}$$

at the time t based on the quarter-scaled cross-attention features

$${R}_{t , TCAM}^{4} ,$$

the full-scale fused features

$${R}_{t}^{1} ,$$

and the half-scale fused features

$${R}_{t}^{2}$$

at the time t. As can be seen, a different respective RFRM 570 is utilized for each image scale (e.g., three different RFRM 570 for the three different image scales). The RFRM 570 for the quartered image scale receives the quarter-scaled cross-attention features

$${R}_{t , TCAM}^{4}$$

from the TCAM 560 and generates the reconstructed quanta image frame

$${O}_{t}^{4}$$

at the quartered image scale. The RFRM 570 for the halved image scale receives the half-scaled fused features

$${R}_{t}^{2}$$

from the RMDF 550 and generates the reconstructed quanta image frame

$${O}_{t}^{2}$$

at the halved image scale. Finally, the RFRM 570 for the full image scale receives the full-scale fused features

$${R}_{t}^{1}$$

from the RMDF 550 and generates the reconstructed quanta image frame

$${O}_{t}^{1}$$

at the full image scale.

Additionally, as can be seen, hidden states

$${f}_{t}^{α}$$

and residual frames

$${r}_{t}^{α}$$

are passed between the RFRM 570 to provide recurrence across the different image scales. In particular, the RFRM 570 for the quartered image scale receives a hidden state

$${f}_{t}^{4}$$

and a residual frame

$${r}_{t}^{4} ,$$

which are initialized as zero because the quarter scale is the smallest image scale. The RFRM 570 for the quartered image scale outputs a hidden state

$${f}_{t}^{2}$$

and a residual frame

$${r}_{t}^{2} ,$$

which are passed to the RFRM 570 for the halved image scale. Finally, the RFRM 570 for the halved image scale outputs a hidden state

$${f}_{t}^{1}$$

and a residual frame

$${r}_{t}^{1} ,$$

which are passed to the RFRM 570 for the full image scale.

It should be appreciated that, considering the heavy noise in the input quanta frames, this ill-posed problem's restored image subspace can be quite large. To output a restored image close to the ground truth, a deep supervision is utilized that lets the model preserve critical details of the scene. A multi-scale reconstruction approach is adopted in which the image at each scale is reconstructed in a progressive fashion. The main purpose of this setup is to initially restore the high-level features by estimating

$${O}_{t}^{4} ,$$

followed by focusing on the low-level, intricate details while refining the residual frames for scales 2 and 1.

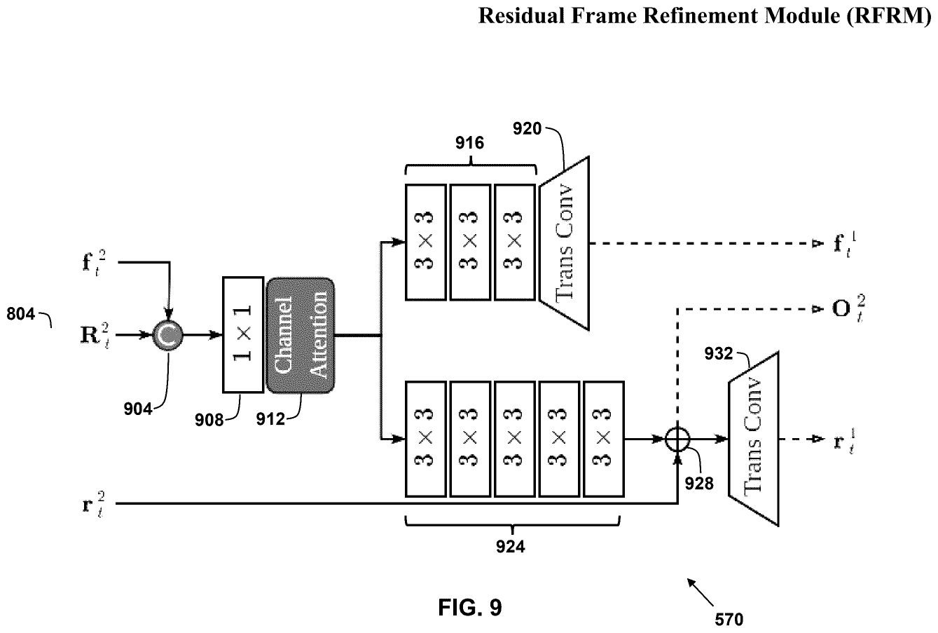

FIG. 9 shows a detailed neural network architecture of the RFRM 570. In the illustration, processing is only shown for one of the image scales (the halved image scale). However, it should be appreciated that this architecture is duplicated for the other image scales. As discussed previously, the RFRM 570 receives the fused features

$${R}_{t}^{α}$$

(or

$${R}_{t , TCAM}^{4} ) ,$$

the hidden state

$${f}_{t}^{a} ,$$

and the residual frame

$${r}_{t}^{α}$$

(i.e., the fused features

$${R}_{t}^{2} ,$$

the hidden state

$${f}_{t}^{2} ,$$

and the residual frame

$${r}_{t}^{2} ) .$$

The fused features

$${R}_{t}^{α}$$

are concatenated with the hidden state

$${f}_{t}^{2}$$

by a concatenation node 904. These concatenated features are passed through a convolutional layer 908 and a channel attention module 912. The output of the channel attention module 912 is duplicated across two different processing paths. In one path, the output of the channel attention module 912 is passed through a sequence of convolutional layers 916 (e.g., three 3×3 layers) before being passed through a transposed convolutional layer 920, which increases the dimensionality of the data, to generate modified hidden state

$${f}_{t}^{a / 2}$$

(e.g., the hidden state

$${f}_{t}^{1} )$$

for the next largest image scale. In the other path, the output of the channel attention module 912 is passed through a sequence of convolutional layers 924 (e.g., five 3×3 layers) before being multiplied with the residual frame

$${r}_{t}^{α}$$

(i.e., the residual frame

$${r}_{t}^{2} )$$

to determine the reconstructed quanta image frame

$${O}_{t}^{α}$$

(e.g.,

$${O}_{t}^{2} ) .$$

Finally, the reconstructed quanta image frame

$${O}_{t}^{α}$$

(e.g.,

$${O}_{t}^{2} )$$

is passed through a transposed convolutional layer 932, which increase the dimensionality of the data, to determine the residual frame

$${r}_{t}^{α / 2}$$

(i.e., the residual frame

$${r}_{t}^{1} )$$

at the next largest image scale.

Once the reconstructed quanta image frames

$${O}_{t}^{1} , {O}_{t}^{2} , and {O}_{t}^{4}$$

are determined, the method 400 can be repeated for the next time step t+1. In this way, the method can be iterated to reconstruct a time series of all of the image frames I in a quanta video. Depending on the application, in at least some embodiments, the computing device 150 outputs the time series of reconstructed image frames O to the display 190 for display thereat. Alternatively, depending on the application, in at least some embodiments, the computing device 150 outputs the time series of reconstructed image frames O to another system, such as an autonomous vehicle navigation system (not shown), for further processing.

In at least some embodiments, the end-to-end neural network 164 is trained using a loss function that incorporates multiple training losses corresponding to the multiple image scales (e.g., 1, 2, and 4). In one embodiment, the overall loss function can be represented as equation (1):

$${ℒ}_{Q} = {λ}_{1} \cdot ℒ ( {I}^{1 , GT} , {I}_{d}^{1} ) + {λ}_{2} \cdot ℒ ( {I}_{t}^{1 , GT} , {O}_{t}^{1} ) + {λ}_{3} \cdot ℒ ( {I}_{t}^{2 , GT} , {O}_{t}^{2} ) + ⋯ {λ}_{4} \cdot ℒ ( {I}_{t}^{4 , GT} , {O}_{t}^{4} )$$

where

$${I}_{t}^{α , GT}$$

is the captured t^{th} ground truth frame bicubically down-sampled by α, and £(Iₐ,I_{b})=∥Iₐ−I_{b}∥₁+∥∇ₓIₐ−∇ₓI_{b}∥₁+∥∇_{y}Iₐ−∇_{y}I_{b}∥₁. Here, ∇ₓ and ∇_{y} represent the operations of computing horizontal and vertical gradients.

### Experimental Results

The method 400 and the end-to-end neural network 164 were experimentally tested and shown to outperform conventional methods by significant margins. To these ends, a high-speed video dataset was constructed, which is referred to herein as the I2-2000FPS dataset. The I2-2000FPS dataset has a temporal resolution of 2000 FPS and a spatial resolution of 512×1024 pixels, comprising 280 unique videos spanning 114 diverse scenes. The videos are captured using the Chronos 1.4 high-speed CMOS sensor-based camera from Kron Technologies. Notably, the I2-2000FPS dataset incorporates dark current calibration, leveraging the camera's capabilities to mitigate dark current effects. Throughout the data collection process, analog and digital gain were consistently maintained at 0 dB to avoid amplification of noise. To minimize noise, the videos are exclusively captured outdoors with ambient lighting conditions.

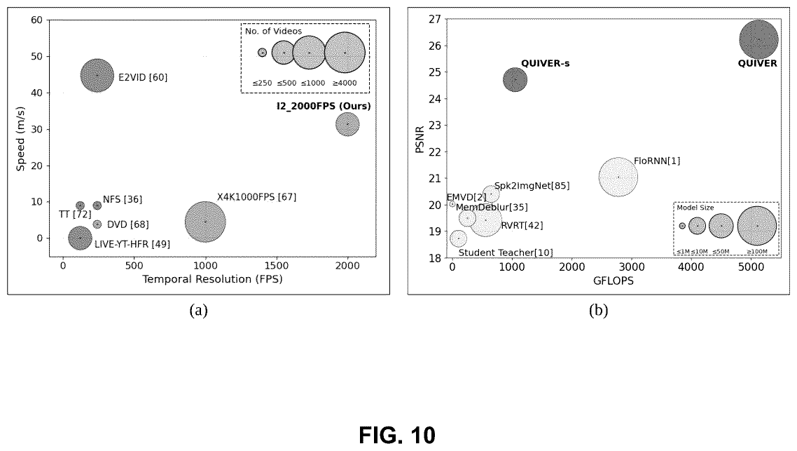

FIG. 10 shows comparisons of the I2-2000FPS dataset and QUIVER with prior datasets and methods. Illustration (a) shows benchmarking of high-speed video datasets. The horizontal axis represents the temporal resolution, and the vertical axis indicates the maximum speed captured by the dataset, assuming a fixed camera-object distance. The circles in blue and orange indicate blur and blur-free videos, respectively. Illustration (b) shows benchmarking of different quanta video restoration models on the I2-2000FPS dataset. The horizontal axis represents the computational complexity in terms of GFLOPs, and the vertical axis indicates the PSNR acquired at 3.25 PPP.

Image Formation Model: For experiments involving synthetic data, we use a single-photon detector simulator based on an underlying image formation model discussed below. We build upon the prototype initially suggested in adopted in prior works.

Given the quanta exposure, I^{GT}, dependent on the photon flux and exposure time, the observed signal by the sensor can be represented as a Poisson-Gaussian random variable, where the Poisson represents the photon arrival process and the Gaussian models the read noise. The readout process involves various sources of distortions and an Analog-to-Digital Converter (ADC) to convert the real numbers into integers {0, 1, 2, . . . , L}, where L=2^{Nbits}−1 depending on the bit-depth (Nbits) allocated to the sensor. The final sensor readout, Y, can be represented using the following equation (2),

$$Y ∼ A D {C}_{[ 0 , L ]} \{ Poisson ( Q E \times {I}^{GT} + {θ}_{dark} ) + {\underbrace{Gauss ( 0 , {σ}_{read}^{2} 1 )}}_{read noise} \} .$$

Akin to previous works, we assume our sensor to be monochromatic as we utilize monochromatic real data in our experiments. For our sensor prototype, we utilize a Quantum Efficiency (QE) of 0.80. The dark current (θ_{dark}) and read noise (σ_{read}) are set to 1.6 e⁻/pix/sec and 0.2 e⁻/pix, respectively.

Training data: We curate a set of 249 videos from the I2-2000FPS collection and employ them as the training dataset for all the deep-learning models in our experiments. Each training sample is fetched on the fly from each clip. A training sample here is defined as a tuple containing the ground-truth/target frames and the 3-bit quanta frames simulated at 3.25 photons-per-pixel (PPP) (˜1 lux assuming a 1.1 μm pixel pitch and a 1/2000 second exposure time) using the image formation model described in Section 5.1.

Testing data: To effectively analyze the performance of various methods, we carefully sample 31 videos from I2-2000FPS containing various motion types, shapes, and speeds. To test the generalizability, we also test the algorithms on X4K1000FPS test dataset containing 15 videos from distinct scenes. Lastly, to measure the performance on real-world data, we collect binary frames using a SPAD sensor and compare the reconstructed outputs. More details will be discussed in Section 5.3.

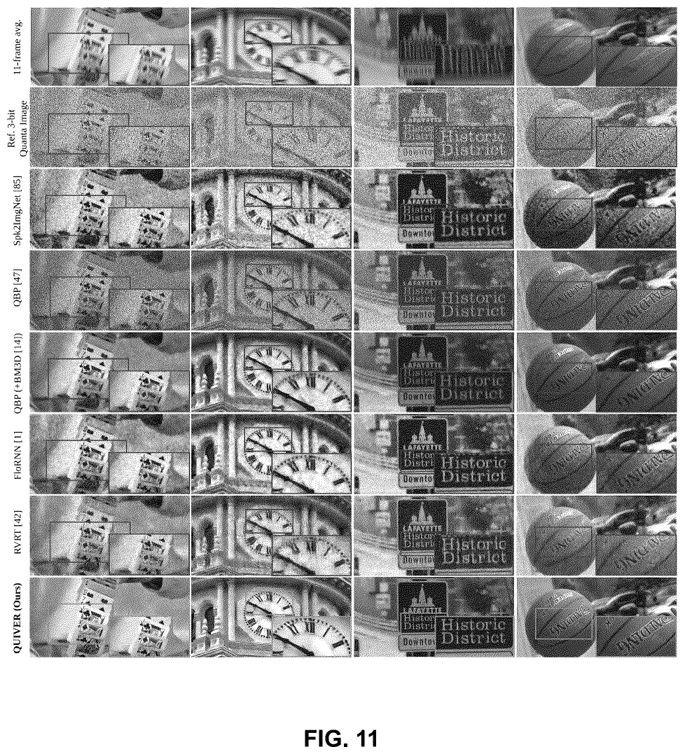

FIG. 11 shows visual comparisons of the reconstructed results on test videos from the I2-2000FPS dataset. For fair comparison, all methods utilize 11 3-bit quanta frames simulated at 3.25 PPP per frame (˜1 lux) to produce a restored frame. Best viewed in zoom.

Baselines: We compare the method with eight existing dynamic scene reconstruction algorithms, namely Transform Denoise, QBP, Student-Teacher, RVRT, EMVD, FloRNN, MemDeblur, and Spk2ImgNet. We also add an off-the-shelf denoiser BM3D to QBP, denoted QBP (+BM3D), as a baseline for comparison. As we will discuss in Section 5.3, QUIVER beats all the baselines, both quantitatively and qualitatively.

Training QUIVER: We utilize the function mentioned in equation (1) as the cost function for training QUIVER with regularization parameters λ₁=0.2, λ₂=0.85, λ₃=0.1, and λ₄=0.05. The training data is extracted with a patch size 228×228 and a batch size of 4. The weights are initialized with Lecun initialization. The network is trained using the Adam optimizer with an initial learning rate of 2.5×10⁻⁵. The low learning rate is driven by the inherent instability of recurrent networks, as it mitigates the risk of divergent behavior during training. We use a learning rate scheduler that reduces the learning rate by a factor of 2 when a plateau is reached. QUIVER takes approximately 1.5 days to train on a NVIDIA A100 Tensor Core GPU using Pytorch.

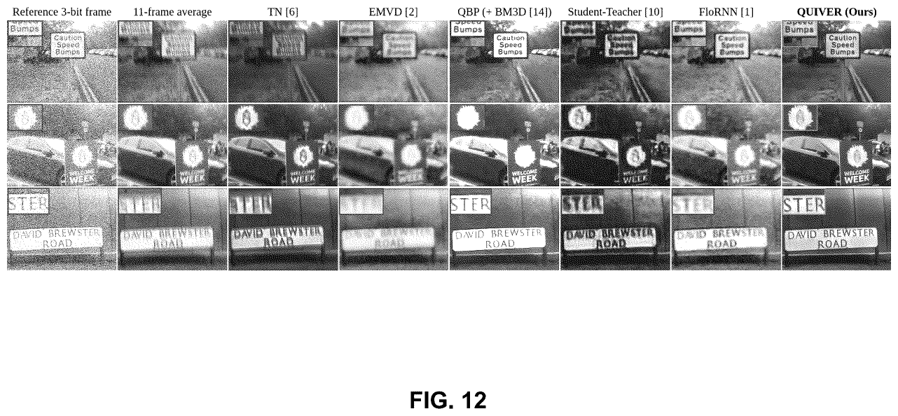

FIG. 12 shows performance on real quanta data. We capture real 1-bit quanta data using a SPAD and generate 3-bit frames through temporal averaging. All deep learning-based models are trained using a photon-level of 4.9 PPP per frame. Best viewed in zoom.

Synthetic Data Experiment Results: We begin with the synthetic experiments where we utilize 3-bit quanta frames, simulated using the parameters mentioned in Section 5.1 at 3.25, 9.75, 19.5, and 26 PPP to test the algorithms' performance. Table 2 and Table 3 demonstrate the PSNR and SSIM of various methods extracted by predicting 6017 I2-2000FPS frames and 345 X4K1000FPS frames. To further substantiate the efficacy of QUIVER's design, we introduced a scaled-down variant, QUIVER-s (Refer to FIG. 10(b) for complexity comparison). Quantitative results indicate that both QUIVER and QUIVER-s offer substantially better performance than all the baselines across a range of light levels. FIG. 11 depicts visual results of all the methods on the I2-2000FPS dataset. It is evident that existing methods fail to handle both motion and noise simultaneously, whereas QUIVER produces blur-free high SNR outputs while preserving high-frequency details to a large extent.

Table 2, below, shows a performance comparison on the I2-2000FPS dataset across various light levels. Models are trained using the I2-2000FPS dataset. QUIVER performs significantly better than the existing methods.

| | Photons-Per-Pixel (PPP) | | | | | | | |
|---|---|---|---|---|---|---|---|---|
| | 3.25 | | 9.75 | | 19.5 | | 26 | |
| Method | PSNR↑ | SSIM↑ | PSNR↑ | SSIM↑ | PSNR↑ | SSIM↑ | PSNR↑ | SSIM↑ |
| Transform Denoise [6] | 21.3170 | 0.7184 | 23.1521 | 0.7671 | 22.7748 | 0.7812 | 22.3096 | 0.7811 |
| QBP [47] | 15.9411 | 0.1293 | 19.1856 | 0.2654 | 20.4000 | 0.3713 | 20.7978 | 0.4114 |
| QBP (+ BM3D [14]) | 21.5476 | 0.7033 | 22.2001 | 0.6899 | 22.8351 | 0.7696 | 22.8617 | 0.7832 |
| Student-Teacher [10] | 18.7200 | 0.4006 | 16.5195 | 0.2479 | 15.7636 | 0.2133 | 13.2889 | 0.0735 |
| RVRT [42] | 19.4115 | 0.3539 | 21.6714 | 0.4568 | 22.0826 | 0.5021 | 21.7528 | 0.4968 |
| EMVD [2] | 20.0194 | 0.5873 | 21.0559 | 0.6048 | 22.4403 | 0.5592 | 23.4053 | 0.5576 |
| FloRNN [1] | 21.0341 | 0.6785 | 25.6132 | 0.7091 | 27.4322 | 0.7395 | 27.8520 | 0.7784 |
| MemDeblur [35] | 19.4877 | 0.3868 | 14.4906 | 0.1112 | 16.1775 | 0.1667 | 16.0058 | 0.1712 |
| Spk2ImgNet [85] | 20.3945 | 0.5642 | 19.6665 | 0.6733 | 22.9372 | 0.7008 | 14.9769 | 0.6861 |
| QUIVER-s (Ours) | 24.7013 | 0.7565 | 26.8676 | 0.7883 | 27.2989 | 0.8432 | 27.8659 | 0.8408 |
| QUIVER (Ours) | 26.2143 | 0.7897 | 26.8058 | 0.8250 | 27.7538 | 0.8563 | 27.9377 | 0.8446 |

Table 2, below, shows a performance comparison on the X4K1000FPS dataset across various light levels. Models are trained using the I2-2000FPS dataset. QUIVER performs significantly better than the existing methods.

| | Photons-Per-Pixel (PPP) | | | | | | | |
|---|---|---|---|---|---|---|---|---|
| | 3.25 | | 9.75 | | 19.5 | | 26 | |
| Method | PSNR↑ | SSIM↑ | PSNR↑ | SSIM↑ | PSNR↑ | SSIM↑ | PSNR↑ | SSIM↑ |
| Transform Denoise [6] | 19.6255 | 0.6323 | 22.1703 | 0.7044 | 22.9938 | 0.7229 | 22.6230 | 0.7204 |
| QBP [47] | 15.5634 | 0.2302 | 16.9758 | 0.3230 | 17.1798 | 0.3957 | 17.7807 | 0.4188 |
| QBP (+ BM3D [14]) | 17.9677 | 0.5123 | 18.5308 | 0.5226 | 18.2407 | 0.5414 | 18.7917 | 0.5586 |
| Student-Teacher [10] | 18.8208 | 0.3652 | 10.1548 | 0.2608 | 14.9359 | 0.2571 | 13.9762 | 0.1186 |
| RVRT [42] | 19.9203 | 0.3641 | 21.0781 | 0.4472 | 21.4780 | 0.4925 | 20.7899 | 0.4919 |
| EMVD [2] | 20.5102 | 0.4836 | 21.8152 | 0.5595 | 22.9440 | 0.5936 | 22.4587 | 0.5860 |
| FloRNN [1] | 20.8283 | 0.5778 | 23.5874 | 0.6484 | 24.3214 | 0.6683 | 25.2483 | 0.7170 |
| MemDeblur [35] | 19.5534 | 0.3642 | 14.5595 | 0.2203 | 16.6749 | 0.3116 | 15.6496 | 0.2974 |
| Spk2ImgNet [85] | 18.9424 | 0.4731 | 19.2532 | 0.5722 | 20.3442 | 0.5716 | 16.0931 | 0.6106 |
| QUIVER-s (Ours) | 20.9197 | 0.5955 | 21.7990 | 0.6523 | 24.1924 | 0.7316 | 23.4411 | 0.7248 |
| QUIVER (Ours) | 21.8730 | 0.6521 | 23.1654 | 0.7057 | 24.5956 | 0.7645 | 25.0086 | 0.7513 |

Real Data Experiments Results: We verify the methods' performance on real data. The real data is collected as binary frames using a SPAD sensor at 10000 FPS with a spatial resolution of 240×320. As SPADs possess zero read noise, the binary frames are summed up to generate 3-bit frames. The average observed light level after summation is 4.9 PPP. FIG. 12 shows visual results with networks trained at 4.9 PPP. QUIVER, as opposed to existing state-of-the-art, effectively recovers high-frequency information while applying a visually appealing smoothening effect to low-frequency regions of the scene. It is noteworthy that SPADs' image formation model is significantly different from that of the QIS's imaging model. Therefore, the visual results also indicate that the proposed QUIVER can thoroughly generalize to various single-photon detectors.

Embodiments within the scope of the disclosure may also include non-transitory computer-readable storage media or machine-readable medium for carrying or having computer-executable instructions (also referred to as program instructions) or data structures stored thereon. Such non-transitory computer-readable storage media or machine-readable medium may be any available media that can be accessed by a general-purpose or special-purpose computer. By way of example, and not limitation, such non-transitory computer-readable storage media or machine-readable medium can comprise RAM, ROM, EEPROM, CD-ROM or other optical disk storage, magnetic disk storage or other magnetic storage devices, or any other medium which can be used to carry or store desired program code means in the form of computer-executable instructions or data structures. Combinations of the above should also be included within the scope of the non-transitory computer-readable storage media or machine-readable medium.

Computer-executable instructions include, for example, instructions and data that cause a general-purpose computer, special-purpose computer, or special-purpose processing device to perform a certain function or group of functions. Computer-executable instructions also include program modules that are executed by computers in stand-alone or network environments. Generally, program modules include routines, programs, objects, components, and data structures etc. that perform particular tasks or implement particular abstract data types. Computer-executable instructions, associated data structures, and program modules represent examples of the program code means for executing steps of the methods disclosed herein. The particular sequence of such executable instructions or associated data structures represents examples of corresponding acts for implementing the functions described in such steps.

While the disclosure has been illustrated and described in detail in the drawings and foregoing description, the same should be considered as illustrative and not restrictive in character. It is understood that only the preferred embodiments have been presented and that all changes, modifications, and further applications that come within the spirit of the disclosure are desired to be protected.

What is claimed is:

1. A method for reconstructing images captured using a single-photon detector array, the method comprising:
receiving, with a processor, a predetermined number of consecutive image frames from a time series of image frames captured using the single-photon detector array, the consecutive image frames including an image frame at a time t; and
generating, with the processor, a reconstructed image frame at the time t based on the consecutive image frames using a neural network.

2. The method according to claim 1, the generating the reconstructed image frame at the time t further comprising:
extracting first spatio-temporal features from the consecutive image frames;
determining optical flows between the image frame at the time t and a subsequent image frame at a subsequent time t+1; and
determining aligned spatio-temporal features at the time t by aligning the first spatio-temporal features based on the optical flows.

3. The method according to claim 2, the generating the reconstructed image frame at the time t further comprising:
determining denoised consecutive image frames by denoising the consecutive image frames; and
extracting second spatio-temporal features from the denoised consecutive image frames,
wherein optical flows between the image frame at the time t and the subsequent image frame at the subsequent time t+1 are determined based on the denoised consecutive image frames.

4. The method according to claim 3, the generating the denoised consecutive image frames further comprising:
denoising the consecutive image frames using a denoiser sub-network of the neural network that incorporates residual dense blocks.

5. The method according to claim 2, the extracting the first spatio-temporal features further comprising:
extracting the first spatio-temporal features using a three-dimensional convolution sub-network of the neural network.

6. The method according to claim 2, the determining the optical flows further comprising:
determining the optical flows using a spatial pyramid sub-network of the neural network.

7. The method according to claim 2, the determining the aligned spatio-temporal features at the time t further comprising:
determining warped spatio-temporal features by warping the first spatio-temporal features based on the optical flows; and
determining the aligned spatio-temporal features at the time t by fusing the warped spatio-temporal features.

8. The method according to claim 7, the determining the warped spatio-temporal features further comprising:
warping the first spatio-temporal features using a deformable convolution sub-network of the neural network.

9. The method according to claim 7, the determining the aligned spatio-temporal features at the time t further comprising:
fusing the warped spatio-temporal features using a gated linear unit-based multi-layer perceptron sub-network of the neural network.

10. The method according to claim 2, the generating the reconstructed image frame at the time t further comprising:
extracting the first spatio-temporal features at multiple image scales;
determining the optical flows at the multiple image scales; and
determining the aligned spatio-temporal features at the multiple image scales.

11. The method according to claim 2, the generating the reconstructed image frame at the time t further comprising:
determining fused features at the time t based on the aligned spatio-temporal features, the image frame at the time t, and a first hidden state at a prior time t−1 resulting reconstructing a prior image frame at the prior time t−1.

12. The method according to claim 11, the determining the fused features further comprising:
determining the fused features at the time t using a first recurrent sub-network of the neural network, the first recurrent sub-network incorporating a residual dense block and recurrence, the first hidden state at the prior time t−1 being an output of the sub-network resulting from reconstructing the prior image frame at the prior time t−1.

13. The method according to claim 11, the determining the fused features further comprising:
scaling the image frame at the time t to multiple image scales; and
determining fused features at the multiple image scales based on the aligned spatio-temporal features at the multiple image scales and the image frame at the time t at the multiple image scales.

14. The method according to claim 11, the generating the reconstructed image frame at the time t further comprising:
extracting cross-attention features based on the fused features at the time t; and
generating the reconstructed image frame at the time t based on the cross-attention features and the fused features at the time t.

15. The method according to claim 14, the extracting the cross-attention features further comprising:
extracting the cross-attention features using a temporal cross-attention sub-network of the neural network based on the fused features at the time t, the fused features at the prior time t−1, and the fused features at a subsequent time t+1.

16. The method according to claim 14, the generating the reconstructed image frame at the time t further comprising:
extracting the cross-attention features at a smallest image scale of multiple image scales based on the fused features at the smallest image scale;
generating the reconstructed image frame at the time t at the smallest image scale of the multiple image scales based on the cross-attention features; and
generating the reconstructed image frame at the time t at each other respective image scale of the multiple image scales, each based on the fused features at the respective image scale and based on a respective residual image at the respective image scale and a respective second hidden state resulting from reconstructing the image frame at a smaller image scale of the multiple image scales than the respective image scale.

17. The method according to claim 16, the generating the reconstructed image frame at the time t at multiple image scales further comprising:
generating the reconstructed image frame at the time t at multiple image scales using a second recurrent sub-network of the neural network, the second recurrent sub-network incorporating a channel attention block and recurrence, the respective residual image at the respective image scale and the respective second hidden state being an output of the sub-network resulting reconstructing the image frame at the smaller image scale.

18. The method according to claim 16, wherein the neural network is trained using a loss function that incorporates multiple training losses corresponding to the multiple image scales.

19. The method according to claim 1, wherein the single-photon detector array includes quanta image sensors or single-photon avalanche diodes.

20. The method according to claim 1, wherein the image frames include 3-bit depth intensity values.
